(19) United States
(12) Patent Application Publication
(10) Pub. No.: US 2019/0152387 A1
(43) Pub. Date: May 23, 2019

(54) AJAR TAILGATE DETECTION SYSTEM

(71) Applicant: GM GLOBAL TECHNOLOGY OPERATIONS LLC, Detroit, MI (US)

(72) Inventors: Mohammad Naserian, Windsor (CA); Shuqing Zeng, Sterling Heights, MI (US); Allan K. Lewis, Windsor (CA)

(73) Assignee: GM GLOBAL TECHNOLOGY OPERATIONS LLC, Detroit, MI (US)

(21) Appl. No.: 15/820,033

(22) Filed: Nov. 21, 2017

(51) Int. Cl. B60Q 9/00; G06K 9/00; H04N 5/225

(52) U.S. Cl. CPC B60Q 9/00; B60R 1/00; H04N 5/2253; G06K 9/00791

(57) ABSTRACT

An ajar tailgate detection system for a vehicle having a parking assist system and a method for controlling the same are provided. The ajar tailgate detection system may include, but not limited to, a camera configured to output image data and a processor communicatively coupled to the camera and the parking assist system, the processor configured to determine when the tailgate is open based upon the image data output from the camera generate, when the tailgate is determined to be open, one of instructions to load a tailgate ajar calibration file into the parking assist system or instructions to disable the parking assist system, the tailgate ajar calibration file defining a second vehicle length and defining a second data acquisition range of the at least one sensor and transmit the generated instructions to the parking assist system.

### INTRODUCTION

The present invention generally relates to vehicles, and more particularly relates to detecting when a tailgate of a vehicle is open.

Parking assist systems typically work well under ideal conditions. Ideal conditions may include, for example, the tailgate of the vehicle being closed. When the tailgate of the vehicle is open, some sensors may receive data reflected from the tailgate which can cause the parking assist system to incorrectly identify an object behind the vehicle or otherwise reduce the functionality of the parking assist system.

Accordingly, it is desirable to improve the functionality of parking assist systems under less than ideal conditions. Furthermore, other desirable features and characteristics of the present invention will become apparent from the subsequent detailed description of the invention and the appended claims, taken in conjunction with the accompanying drawings and the background of the invention.

### SUMMARY

In one embodiment, for example, a vehicle is provided. The vehicle may include, but is not limited to, a tailgate, a parking assist system comprising at least one sensor configured to generate instructions based upon a calibration file, the calibration file defining a first vehicle length and defining a first data acquisition range of the at least one sensor, and an ajar tailgate detection system, including, but not limited to, a camera configured to output image data and a processor communicatively coupled to the camera and the parking assist system, the processor configured to determine when the tailgate is open based upon the image data output from the camera generate, when the tailgate is determined to be open, one of instructions to load a tailgate ajar calibration file into the parking assist system or instructions to disable the parking assist system, the tailgate ajar calibration file defining a second vehicle length and defining a second data acquisition range of the at least one sensor and transmit the generated instructions to the parking assist system.

In another embodiment, for example, method for controlling an ajar tailgate detection system is provided. The method may include, but is not limited to, receiving, by a processor of the ajar tailgate detection system, image data output from a camera, determining, by the processor, when a tailgate of a vehicle is open based upon the received image data output from the camera, generating, by the processor when the tailgate is determined to be open, one of instructions to load a tailgate ajar calibration file into a parking assist system or instructions to disable the parking assist system, the tailgate ajar calibration file defining a vehicle length and defining a data acquisition range of a at least one sensor of the parking assist system, and transmitting, by the processor, the generated instructions to the parking assist system.

In yet another embodiment, for example, an ajar tailgate detection system for a vehicle is provided. The ajar tailgate detection system may include, but is not limited to, a camera configured to output image data, and a processor communicatively coupled to the camera, the processor configured to determine when the tailgate of the vehicle is open based upon one of detecting that a predetermined part of the vehicle is within the image data output from the camera or determining when a number of edges of the vehicle within the image data is greater than a predetermined threshold.

### BRIEF DESCRIPTION OF THE DRAWINGS

The present invention will hereinafter be described in conjunction with the following drawing figures, wherein like numerals denote like elements, and

FIG. 1 is a block diagram of a vehicle, in accordance with an embodiment;

FIG. 2 illustrates a rear end of an exemplary vehicle, in accordance with an embodiment;

FIG. 3 is a flow chart illustrating a method for operating the ajar tailgate detection system, in accordance with an embodiment;

FIGS. 4 and 5 illustrate a cargo bed located camera located and a tailgate which is lowered when open, in accordance with an embodiment; and

FIG. 6 illustrates image data from a camera mounted on the tailgate of a truck itself, in accordance with an embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

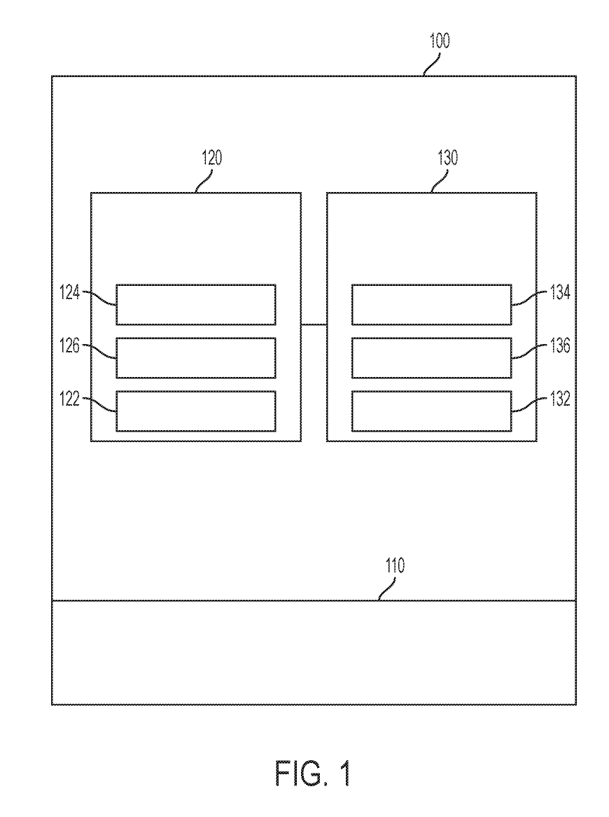

FIG. 1 is a block diagram of a vehicle 100, in accordance with an embodiment. The vehicle 100 includes a tailgate 110. The tailgate 110 is a door or gate at the back of the vehicle 100. In one embodiment, for example, the vehicle 110 may be a truck. However, in other embodiments, the vehicle 100 may be a sports utility vehicle, a crossover, a station wagon, a hatchback or the like.

Unlike a trunk hood typically found in a sedan, the tailgate 110 when lowered or otherwise opened, extends the length of the vehicle 100 by extending beyond a bumper of the vehicle 100. In one embodiment, for example, the tailgate 110 may be hinged at a bottom of the tailgate 110 allowing the tailgate 110 to be lowered to access a truck bed or trunk of the vehicle 100. In other embodiments, for example, the tailgate 110 may be hinged at one or more sides of the tailgate 110, allowing the tailgate to swing out from one or both sides of the vehicle 100. In yet other embodiments, the tailgate 110 may be hinged at a top of the tailgate 110 such that the tailgate 110 is raised when the tailgate 110 is opened. However, the tailgate 110 could include one or more parts hinged in any combination of the possible configurations.

The vehicle 100 further includes a parking assist system 120. The parking assist system 120 utilizes one or more sensors 122 to assist a driver to park the vehicle 100 or to move the vehicle 100 into position to be hitched to a trailer. The sensor(s) 122 may be, for example, one or more optical cameras, radar sensors, light detection and ranging (LIDAR) sensors, ultrasonic sensors, or the like, or any combination thereof. In one embodiment, for example, the parking assist system 120 may automatically move the vehicle 100. In other words, the parking assist system 120 may automatically operate a braking system, an acceleration system and a steering system to move the vehicle into a parking space or into position to be hitched to a trailer. In other embodiments, for example, the parking assist system 120 may provide guidance to the driver in the form of visual instructions, audio instructions, tactile feedback instructions or any combination thereof to park the vehicle 100 or position the vehicle 100 to be hitched to a trailer.

The parking assist system 120 further includes a processor 124 and a memory 126. The processor 124 may be, for example, a central processing unit (CPU), a graphics processing unit (GPU), an application specific integrated circuit (ASIC), a field programmable gate array (FPGA), a microcontroller or any other logic device or combination thereof. The processor 124 may be coupled to the sensor(s) 122 and the memory 126 via any wired or wireless communication bus, or any combination thereof. The processor 124 may be dedicated to the parking assist system 120 or may be shared by one or more other systems in the vehicle 100. The memory 126 may be any combination of volatile and non-volatile memory. The memory 126 may be a non-transitory computer readable medium storing instructions, which when executed by the processor 124, implement the parking assist system 120.

The memory 126 may also store one or more calibration files. The calibration files may include, for example, a default calibration file and one or more a tailgate ajar calibration file. The default calibration file may define one or more operating parameters for the parking assist system. For example, the default calibration file may define a length of the vehicle 100. The one or more tailgate ajar calibration files may define different operating parameters for the parking assist system when the tailgate 110 is open, as discussed in further detail below. Multiple calibration files for an ajar tailgate 110 may be used when the tailgate has multiple opening configurations or positions. For example, a tailgate 110 could include multiple components which could be moved independent of each other, or a tailgate may have multiple open positions (e.g., a tailgate which is completely open or a tailgate 110 which is mechanically held or manually tied in a partially open position.

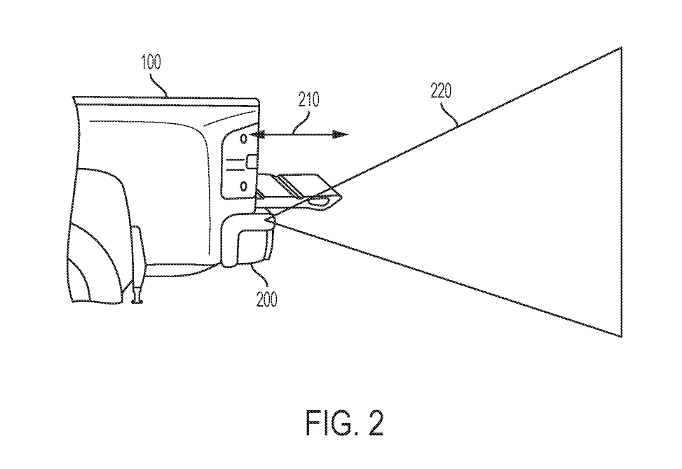

FIG. 2 illustrates a rear end of an exemplary vehicle 100, in accordance with an embodiment. As seen in FIG. 2, the tailgate 110 of the vehicle 100 is lowered. Because the tailgate 110 is lowered, the tailgate extends the length of the vehicle 100 beyond a bumper 200 of the vehicle 100 by a length of the tailgate, as indicated by arrow 210. The tailgate 110, when opened, can cause undesirable effects on the operation of the parking assist system 120 in two ways. Firstly, the tailgate 110 when open extends the length of the vehicle 100 which, if the parking assist system 120 does not take into account, could cause a parking misalignment. Secondly, the tailgate could interfere with one or more of the sensors 122 of the parking assist system 120. A sensor (not illustrated in FIG. 2), may have a data acquisition range 220 as illustrated in FIG. 2. As seen in FIG. 2, the tailgate 110 may overlap a portion of the data acquisition range 220. The overlap of the tailgate 110 may cause a reflection of the sensor signal, and, thus, a misidentification of an object by the parking assist system 120.

Returning to FIG. 1, the vehicle 100 further includes an ajar tailgate detection system 130. The ajar tailgate detection system 130 determines when the tailgate 110 of the vehicle 100 is open. The ajar tailgate detection system 130 includes an optical camera 132. Image data output from the optical camera 132 is used to determine when the tailgate 110 is open, as discussed in further detail below. In one embodiment, for example, the optical camera 132 may be dedicated solely to the ajar tailgate detection system 130. However, the optical camera 132 may be used by one or more other systems in the vehicle 100. For example, the optical camera 132 could be one of the sensors 122 of the parking assist system 120, the optical camera 132 could be a rear view camera, the optical camera 132 could be a cargo bed camera, or the like or any combination thereof.

The optical camera 132 could be mounted in a variety of locations on the vehicle 100. In one embodiment, for example, the optical camera 132 may be mounted on the tailgate 110 of the vehicle 100. In another embodiment, for example, the optical camera 132 may be a cargo bed camera or a full display mirror (FDM) camera.

The ajar tailgate detection system 130 further includes a processor 134 and a memory 136. The processor 134 may be, for example, a central processing unit (CPU), a graphics processing unit (GPU), an application specific integrated circuit (ASIC), a field programmable gate array (FPGA), a microcontroller or any other logic device or combination thereof. The processor 134 may be coupled to the camera 132 and the memory 136 via any wired or wireless communication bus, or any combination thereof. The processor 134 may be dedicated to the ajar tailgate detection system 130 or may be shared by one or more other systems in the vehicle 100. The memory 136 may be any combination of volatile and non-volatile memory. The memory 136 may be a non-transitory computer readable medium storing instructions, which when executed by the processor 134, implement the ajar tailgate detection system 130, as discussed in further detail below.

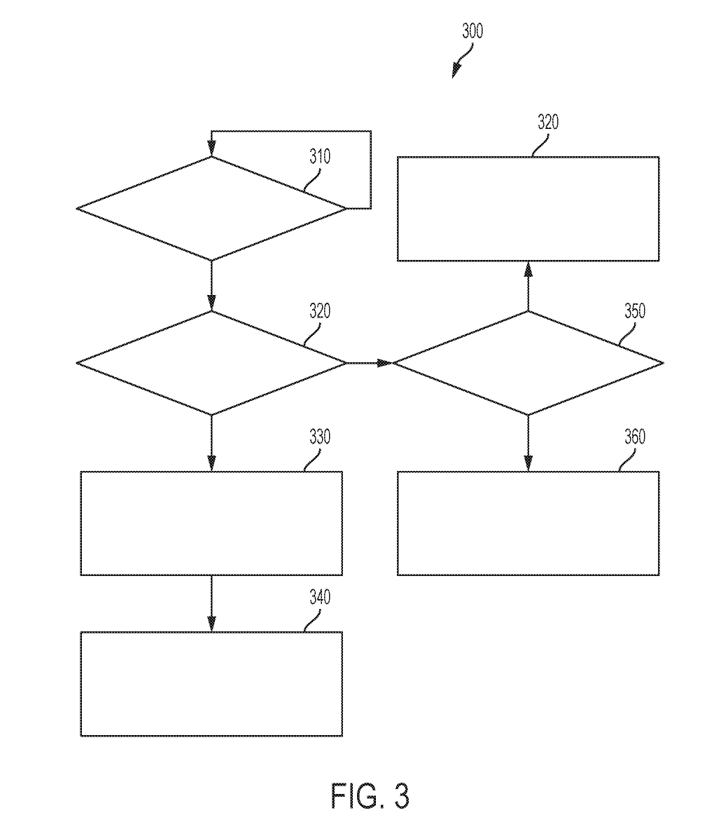

FIG. 3 is a flow chart illustrating a method 300 for operating the ajar tailgate detection system 130, in accordance with an embodiment. The processor 134 of the ajar tailgate detection system 130 first determines when the vehicle 100 is in reverse. (Step 310). The processor 134 may determine that the vehicle is in reverse by, for example, receiving a related message from vehicle's transmission system directly or through a gateway module, or the like. When the vehicle 100 is in reverse, the parking assist system 120 is activated. In one embodiment, for example, the parking assist system 120 may receive an activation command from the processor 134 when the processor 134 determines that the vehicle 100 is in reverse. However, in other embodiments, the parking assist system 120 may be activated independent of the ajar tailgate detection system 130.

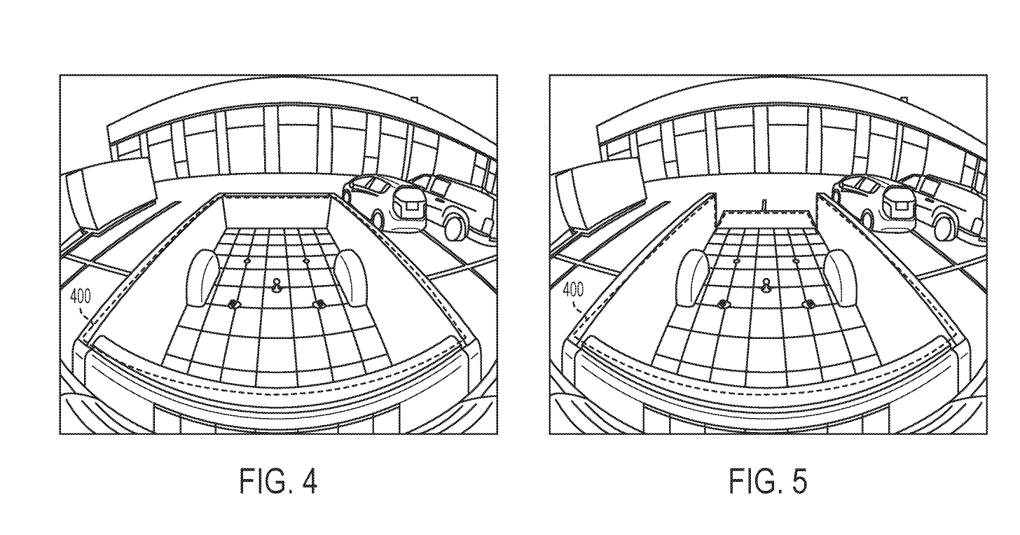

When the vehicle 100 is determined to be in reverse, the processor 134 analyzes image data output by the camera 132 to determine if the tailgate is open. (Step 320). The image data may be processed based upon where the camera 132 is located and the type of tailgate 110 on the vehicle 100. In one embodiment, for example, the processor 134 may determine when the tailgate 110 is open or closed based upon an outline of part of the vehicle 110 or number of edges of the vehicle 110 visible in the camera image data. FIGS. 4 and 5 illustrate a cargo bed camera (i.e., a camera mounted to view the cargo bed of a truck) and a tailgate 110 which is lowered when open, in accordance with an embodiment. In particular, FIG. 4 illustrates a truck with a tailgate 110 in a closed position and FIG. 5 illustrates a truck with a tailgate 110 in an open (i.e., lowered) position. In this embodiment, the processor 134 may process the image data output by the camera 132 to determine an outline 400 and a number of edges in the outline 400 of the cargo bed. Various image classification methods could be used to determine the tailgate status. For example, if a cargo-bed camera is not occluded, a template match algorithm (e.g., correlation operation) can be applied to match the template of a closed tailgate (in quadrilateral area) to the image captured by the cargo-bed camera. If a matching score (the similarity metrics computed from color, edgeness, pixel, or machine derived feature vector derived from neural network) is less than a threshold, then gate may be determined as open. In one embodiment, for example, the matching quadrilateral area can be split into multiple vertical slices. The same algorithm can be applied to each slice.

In another embodiment, the processor 134 may determine when the tailgate is open or closed based upon whether a predetermined part of the vehicle 100 is in the camera 132 image data. In one embodiment, for example, if the cargo-bed is significantly occluded, the ajar tailgate detection system 130 may switch to a rear-view camera to determine the tailgate's status. However, the ajar tailgate detection system 130 could be implemented only with one of the cargo-bed camera or the rear-view camera. When a rear-view camera is used, a two-class classifier may be trained with images captured by rear-view camera to determine the tailgate status.

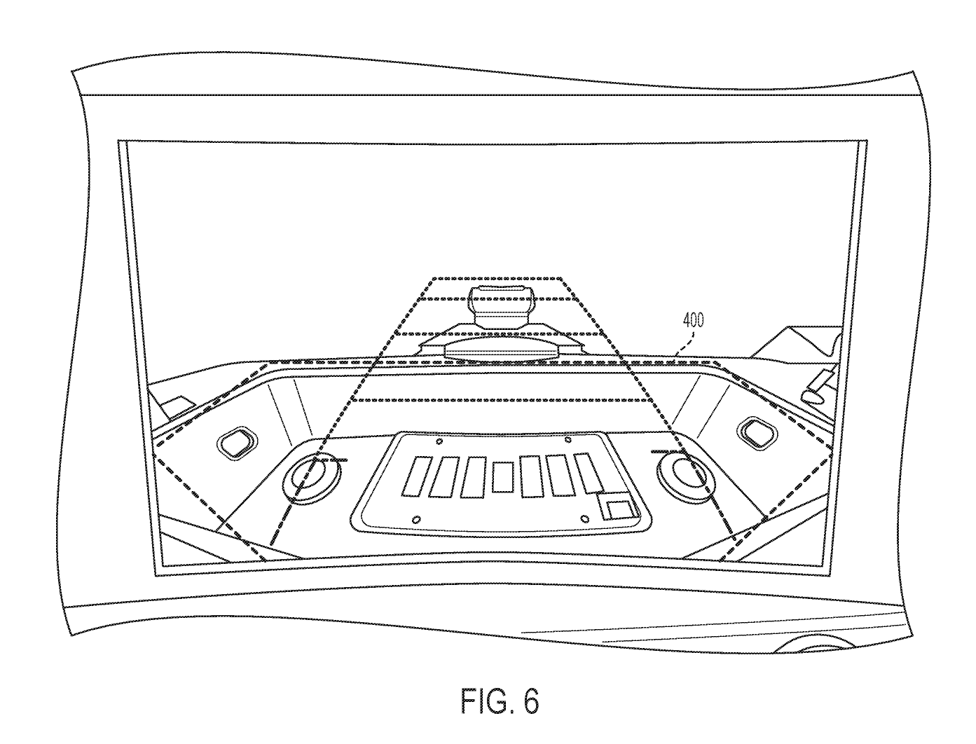

FIG. 6 illustrates image data from a camera 132 mounted on the tailgate 110 of a truck itself, in accordance with an embodiment. In this embodiment, the camera 132 may be a rear view camera which is configured to show an image of what is behind the vehicle 100 on a display within the vehicle 100. When the tailgate is closed, the camera would be pointed towards whatever is behind the vehicle 100. In contrast, and as illustrated in FIG. 6, when the tailgate is open (i.e., lowered), the rear bumper and license plate of the vehicle 100 are visible in the image data. The processor 134 may thus determine that the tailgate 110 is lowered when an outline of a predetermined part of the vehicle 110 (in this example the license plate holder on the bumper of a truck) having a predetermined outline 400 within the camera 132 image data. In other words, if the processor 134 detects an outline of an object in the image data which has a size and shape which matches the size and shape of the predetermined part, the processor determines that the tailgate is open. The predetermined outline 400 may be determined experimentally and stored in the memory 136.

One benefit of utilizing a rearview camera or a cargo bed camera to determine when a tailgate 110 is open is that the ajar tailgate detection system 130 can leverage existing equipment on the vehicle 100 rather than using a dedicated camera or specific sensors on the tailgate, thereby reducing the cost of the ajar tailgate detection system 130.

Returning to FIG. 3, when the processor 134 determines that the tailgate 110 is open, the processor 134 can optionally generate an open tailgate warning. (Step 330). The warning can be a visual warning (i.e., on a display within the vehicle), an audible warning, a tactile feedback warning (i.e., vibration of the steering wheel, driver's seat or the like), or any combination thereof. The warning is optional as the parking assist system may be compensated for the open tailgate 110, as discussed in further detail below, thus rendering the warning unnecessary.

The processor 134, in response to determining that the tailgate 110 is open, may instruct the parking assist system 120 to load an ajar tailgate calibration file or transmit disabling instructions to the parking assist system 120. (Step 340). As discussed above, the parking assist system 120 may function based upon a calibration file stored in the memory 126. The calibration file may define parameters that the parking assist system 120 uses to control the vehicle or generate instructions for the driver. The parameters include, for example, the length of the vehicle. The default calibration file for the parking assist system 120 may include a bumper-to-bumper length as the vehicle length. However, when the tailgate 110 is open, the tailgate 110 extends beyond the rear bumper of the vehicle. Accordingly, the parameter for the vehicle length in the ajar tailgate calibration file may be the length of the vehicle 100 from a front bumper to the end of the tailgate when opened.

Another parameter in the calibration files may be a data acquisition range of the sensors 122 of the parking assist system. As illustrated in FIG. 2, the tailgate 110 when open may reflect sensor data. The reflection may be, for example, an optical reflection, a radio frequency (RF) reflection, or any combination thereof depending upon the sensors 122 of the parking assist system 120. The area within the sensor data where the reflection occurs can be determined in advance via, for example, experimentation or other calibration. Accordingly, the ajar tailgate calibration file may be configured the parking assist system 120 to ignore any portion of the sensor data where the known reflection from the tailgate 110 would occur. In other words, by ignoring any portion of the sensor data where the known reflection from the tailgate would occur, the ajar tailgate calibration file alters the sensor(s) 122 data acquisition range to only collect data in areas where the tailgate 110 is not blocking the sensor(s) 120. By reconfiguring the sensor acquisition range of the parking assist system 120 when the tailgate 110 is open, the ajar tailgate detection system 130 allows the parking assist system 120 to function as fully as possible when the tailgate 110 is open.

As discussed above, the processor 134 could also instruct the parking assist system 120 to turn off when the tailgate 110 is determined to be open. For example, the processor 134 could also instruct the parking assist system 120 to turn off when an object is detected to be within a certain distance of the tailgate 110.

When the tailgate is determined to be closed in Step 320, the processor 134 of the ajar tailgate detection system 130 and/or the processor 124 of the parking assist system, depending upon the position of the sensor(s) 122 and camera 132, may determine if the vehicle 100 is being hitched to a fifth wheel/gooseneck style trailer. (Step 350). The respective processor may determine that vehicle 100 is being hitched to a fifth wheel/gooseneck style trailer based upon a user selection of a hitch type or by analyzing data from the camera 132 or sensors 122 to determine the hitch type. When the vehicle 100 is being hitched to a fifth wheel/gooseneck style trailer, the tailgate 110 of the vehicle 100 typically has to be open.

When the respective processor determines that the vehicle 100 is being hitched to a fifth wheel/gooseneck style trailer and the tailgate is closed, as previously determined in Step 320, the respective processor may generate a tailgate closed warning. (Step 360). The warning can be a visual warning (i.e., on a display within the vehicle), an audible warning, a tactile feedback warning (i.e., vibration of the steering wheel, driver's seat or the like), or any combination thereof. In one embodiment, for example, the parking assist system 120 may also generate instructions to stop the vehicle (either by controlling a braking system of the vehicle 100 itself or generating instructions for the driver to stop the vehicle 100) until the tailgate is opened.

When respective processor determines that the vehicle 100 is not being hitched to a fifth wheel/gooseneck style trailer and the tailgate 110 is closed, the processor loads the default tailgate calibration file into the parking assist system 120 if not already loaded therein. (Step 370).

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It being understood that various changes may be made in the function and arrangement of elements described in an exemplary aspect without departing from the scope of the invention as set forth in the appended claims.

What is claimed is:

1. A vehicle, comprising:
a tailgate;
a parking assist system comprising at least one sensor configured to generate instructions based upon a calibration file, the calibration file defining a first vehicle length and defining a first data acquisition range of the at least one sensor; and
an ajar tailgate detection system, comprising:
a camera configured to output image data; and
a processor communicatively coupled to the camera and the parking assist system, the processor configured to:
determine when the tailgate is open based upon the image data output from the camera;
generate, when the tailgate is determined to be open, one of instructions to load a tailgate ajar calibration file into the parking assist system or instructions to disable the parking assist system, the tailgate ajar calibration file defining a second vehicle length and defining a second data acquisition range of the at least one sensor; and
transmit the generated instructions to the parking assist system.

2. The vehicle of claim 1, wherein the first vehicle length is a length of the vehicle when the tailgate is closed and the second vehicle length is a length of the vehicle when the tailgate is open.

3. The vehicle of claim 1, wherein the first data acquisition range of the at least one sensor is a larger range than the second data acquisition range.

4. The vehicle of claim 3, wherein the second data acquisition range excludes an area of the first data acquisition range based upon sensor data reflected by the tailgate when the tailgate is open.

5. The vehicle of claim 1, wherein the camera is mounted on the tailgate.

6. The vehicle of claim 5, wherein the processor is configured to determine when the tailgate is open based upon detecting a predetermined part of the vehicle in the output image data.

7. The vehicle of claim 6, wherein the predetermined part is a bumper of the vehicle.

8. The vehicle of claim 1, wherein the camera is a cargo bed camera.

9. The vehicle of claim 8, wherein the processor is configured to determine when the tailgate is open based upon edges of the vehicle in the output image data.

10. A method for controlling an ajar tailgate detection system, comprising:
receiving, by a processor of the ajar tailgate detection system, image data output from a camera;
determining, by the processor, when a tailgate of a vehicle is open based upon the received image data output from the camera;
generating, by the processor when the tailgate is determined to be open, one of instructions to load a tailgate ajar calibration file into a parking assist system or instructions to disable the parking assist system, the tailgate ajar calibration file defining a vehicle length and defining a data acquisition range of a at least one sensor of the parking assist system; and
transmitting, by the processor, the generated instructions to the parking assist system.

11. The method of claim 10, wherein the vehicle length is a length of the vehicle when the tailgate is open.

12. The method of claim 10, wherein the data acquisition range excludes an area of the full data acquisition range of the at least one sensor based upon sensor data reflected by the tailgate when the tailgate is open.

13. The method of claim 10, wherein the camera is mounted on the tailgate.

14. The method of claim 13, wherein the determining further comprises determining when the tailgate of the vehicle is open when a predetermined part of the vehicle in the output image data.

15. The method of claim 14, wherein the predetermined part is a bumper of the vehicle.

16. The method of claim 10, wherein the camera is a cargo bed camera.

17. The method of claim 10, wherein the determining further comprises determining when the tailgate of the vehicle is open when a number of edges of the vehicle in the image data exceeds a predetermined threshold.

18. An ajar tailgate detection system for a vehicle comprising a tailgate, comprising:
a camera configured to output image data; and
a processor communicatively coupled to the camera, the processor configured to:
determine when the tailgate of the vehicle is open based upon one of:
detecting that a predetermined part of the vehicle is within the image data output from the camera; or
determining when a number of edges of the vehicle within the image data is greater than a predetermined threshold.

19. The ajar tailgate detection system of claim 18, wherein the camera is mounted on the tailgate of the vehicle.

20. The ajar tailgate detection system of claim 18, wherein the camera is a cargo bed camera.
